(19) United States
(12) Patent Application Publication
(10) Pub. No.: US 2010/0295413 A1
(43) Pub. Date: Nov. 25, 2010

(54) DEVICE COMPRISING A CAPACITIVE ENERGY CONVERTER THAT IS INTEGRATED ON A SUBSTRATE

(75) Inventors: Gerald Eckstein, München (DE); Ingo Kühne, München (DE)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, MÜNCHEN (DE)

(21) Appl. No.: 12/439,419

(22) PCT Filed: Aug. 29, 2007
(86) PCT No.: PCT/EP2007/058975

§ 371 Date: Feb. 27, 2009

(30) Foreign Application Priority Data
Aug. 31, 2006 (DE) 10 2006 040 725.3

(51) Int. Cl. H02N 1/06

(52) U.S. Cl. 310/300

(57) ABSTRACT

The embodiments relate to a device, especially a microsystem, which comprises an energy converter unit having an electrode structure for the capacitive conversion of mechanical energy to electrical energy The electrode structure includes a first electrode and a second electrode the distance of which to the first electrode is variable. The device according to the invention also comprises a load circuit via which the first and second electrode are interconnected in an electroconductive manner. A transmitter is coupled to the second electrodes. The distance between the first and the second electrode can be varied by displacing the transmitter and the displacement of the transmitter can be effected in a countactles manner by interaction of the transmitter with a mobile part.

### CROSS REFERENCE TO RELATED APPLICATIONS

This application is based on and hereby claims priority to International Application No. PCT/EP2007/058975 filed on Aug. 29, 2007, and German Application No. 10 2006 040 725.3, filed Aug. 31, 2006, the contents of both of which are hereby incorporated by reference.

### BACKGROUND

1. Field

The embodiments discussed herein relate to a device, in particular a microsystem, with an energy conversion unit.

2. Description of the Related Art

In sensor, actuator and data communication technology there is an increasing need for autonomous microsystems which are independent of an external power supply and which ensure cableless and maintenance-free operation. Conventional autonomous microsystems are based for example on the use of solar energy and include solar cells to convert the solar energy into electrical energy. Owing to the dependence of these systems on the sun or other suitable light sources, however, their area of application is very restricted. Furthermore, difficulties result for such systems with increasing miniaturization and integration in conventional CMOS technology.

A known device for converting mechanical energy into electrical energy is based on electrostatic induction and uses an electret to produce energy. On a first electrode an electret film is arranged which is provided with an electrical charge, and the first electrode is connected to a mass potential. A second electrode is arranged at a distance from the first electrode and connected to the mass potential via a load circuit. The electret film is arranged between the first and second electrodes. By a movement of the second electrode along a direction parallel to the main surface of the first electrode the area overlapping from the first and second electrodes changes and as a result the charge induced in the first electrode also changes. This leads to a current flow from the second electrode to the mass potential.

A further device known to the applicant for converting mechanical energy into electrical energy comprises a first electrode made of a first material, which exhibits a first work function for charge carriers, and a second electrode made of a second material, which exhibits a second work function for charge carriers, whereby the second work function is different from the first work function. The first electrode and the second electrode are connected to each other in an electrically conductive manner via a load circuit. Because the second electrode is arranged at a variable distance from the first electrode, an oscillating current can be induced in the load circuit simply by introducing an oscillation in the device.

### SUMMARY

An aspect of an embodiment discussed herein provides a mechanism of energy conversion for a device, in particular for a microsystem, simply, effectively and cost-efficiently. The device should be integratable in conventional semiconductor technologies and essentially maintenance-free. Further requirements may include cableless operation and optimal miniaturization of the device. The device should in particular be usable as a sensor, as an actuator and/or for data transmission and/or for in-situ diagnosis and/or as an energy source or generator and/or as a signal transmitter.

Another aspect is to facilitate in-situ diagnosis of moving, in particular rotating parts simply and autonomously.

A device in accordance with the embodiments, in particular a microsystem, includes an energy conversion unit which exhibits an electrode structure for the capacitive conversion of mechanical energy into electrical energy, whereby the electrode structure exhibits a first electrode and a second electrode, the distance of which to the first electrode is variable. The device further comprises a load circuit via which the first and second electrodes are connected to each other in an electrically conductive manner. A transmitter is coupled to the second electrode. The distance between the first and second electrodes can be changed by moving the transmitter and the movement of the transmitter can be effected contactlessly by interaction of the transmitter with a moving part.

The solution for energy conversion is therefore achieved by converting mechanical energy, in particular the movement of a part located adjacent to the device, initially in its form and then into electrical energy. This means that the movement energy of the part is used to mechanically activate the electrode structure of the device and to vary the distance between the first and the second electrodes. The change in distance brings about a change in the capacitance of the capacitor formed from the first and the second electrodes and leads via the load circuit to a current flow between the first and second electrodes, which can be converted into electrical energy by the load circuit. As a result, mechanical energy is converted into electrical energy.

The energy conversion unit forms a generator which essentially represents a spring-mass system which is able to convert mechanical energy into electrical energy. The electrical energy is therefore available for an autonomous microsystem, e.g. for in-situ diagnosis, or it can be intermediately stored. The mechanical energy to be converted is received by the generator in that it is coupled to the adjacent, monitored part which executes a movement while being monitored.

In accordance with an advantageous configuration, the movement of the transmitter can be brought about by magnetic interaction of the transmitter with the moving part, sections of which exhibit magnetic properties. The displacement of the transmitter and thus of the electrode structure takes place through attracting/and or repelling forces, whereby the movement can be transmitted contactlessly to the transmitter. This results in the advantage that e.g. to monitor the moving part no or only slight design changes are necessary.

In accordance with an advantageous configuration, the movement of the transmitter is brought about by a rotating part, causing a periodic movement or oscillation of the transmitter and the electrode structure. The device in accordance with the invention is therefore suitable in particular for the contactless and autonomous monitoring of rotational machinery, e.g. shafts and turbines.

In accordance with an advantageous configuration, the transmitter exhibits permanent magnetic properties. These can be provided by a permanent magnetic layer or a permanent magnet.

Expediently, before the start of a change in distance the first and second electrodes exhibit a difference in potential. In other words this means that the capacitor formed by the first and second electrodes is “charged”.

The electrode structure can be charged by an electret or a charging capacitor or by utilizing a difference in the work functions of the materials of the first and second electrodes. In the latter case the first and second electrodes are made of different materials with different work functions, so that the capacitor exhibits an integrated bias voltage. As a result of the bias voltage and the provision of an electrically conductive connection between the first and second electrodes a current flows between the first and second electrodes corresponding to the difference in potential between the first and second electrodes. As explained above, the electrical connection between the first and second electrodes is made by inserting a load circuit. This is configured to convert the current flowing between the first and second electrodes into electrical energy. Preferably the materials of the first electrode and the second electrode are selected in such a way that the difference between the work function of the first electrode and the second work function of the second electrode is as big as possible. For example, the first electrode can exhibit silicon and the second electrode can exhibit platinum, titanium or palladium. Other materials can, however, also be used to form the first electrode and the second electrode.

In accordance with a further configuration, the second electrode is arranged on a spring-mounted additional mass and the transmitter is provided on the additional mass. By mounting the second electrode on the spring-mounted additional mass the oscillation behavior between the first and second electrodes can be specifically influenced.

In accordance with a further configuration, the second electrode and the transmitter are located on opposite surfaces of the additional mass. This enables in particular the transmitter to be optimally arranged in relation to the moving part. Furthermore, the properties of the capacitor are not influenced by the transmitter.

In accordance with a further configuration, the spring-mounted additional mass is formed in a first wafer, whereby on a first surface of the first wafer a second wafer is applied on which, facing towards the second electrode on the additional mass, the first electrode is located at a distance from the second electrode. In addition, in accordance with a further configuration, a third wafer can be arranged on a second surface of the first wafer opposite the first surface, so that the additional mass can oscillate with the second electrode and the transmitter in an encapsulated cavity. This protects the energy conversion unit from mechanical loadings and enables the friction losses in the oscillation of the additional mass with the second electrode and the transmitter to be reduced by evacuating the cavity.

In accordance with a further advantageous configuration, the electrode structure is provided as a spring-mass system with a resonance frequency in such a way that this lies within a frequency band of a movement of the part interacting with the transmitter. The operation of the electrode structure with resonance frequency makes it possible to achieve a maximized energy yield.

In accordance with a further advantageous configuration, the resonance frequency of the electrode structure can be adjusted in particular by variation of the mass and/or spring rigidity.

In accordance with a further advantageous configuration, the energy conversion unit is configured as a sensor, as an actuator, for use in data communication as well as in automotive and automation technology and/or as an energy source and/or as a signal transmitter and/or as a diagnostic tool.

The invention further provides a system with a moving part and a device, in particular a microsystem, for energy conversion, whereby through the movement of the part a mechanical movement of the device's transmitter can be produced contactlessly by interaction with the part, whereby the mechanical movement of the transmitter can be converted into electrical energy by the device. The device used for this is configured as described above. The system exhibits the same advantages as already described in connection with the device in accordance with the invention.

In accordance with a further configuration, the moving part is a rotational machine, such as a shaft, a turbine or a blade wheel. The energy needed for activating the electrode structure can, however, also be obtained from a part performing a linear movement.

In accordance with a further configuration, at regular intervals on the moving part a second means of transmission is provided which contactlessly displaces the transmitter.

In accordance with a further configuration, the second means of transmission is formed by a ferromagnetic material, in particular iron, cobalt or nickel, or a permanent magnet.

In accordance with a further configuration, the second means of transmission is formed by the rotational machine itself, e.g. the blades of a turbine, if this is made of a ferromagnetic material, or is arranged on it, e.g. on the turbine blades.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 shows an exemplary embodiment of a device in accordance with the invention for converting energy and a moving part contactlessly coupled to it.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

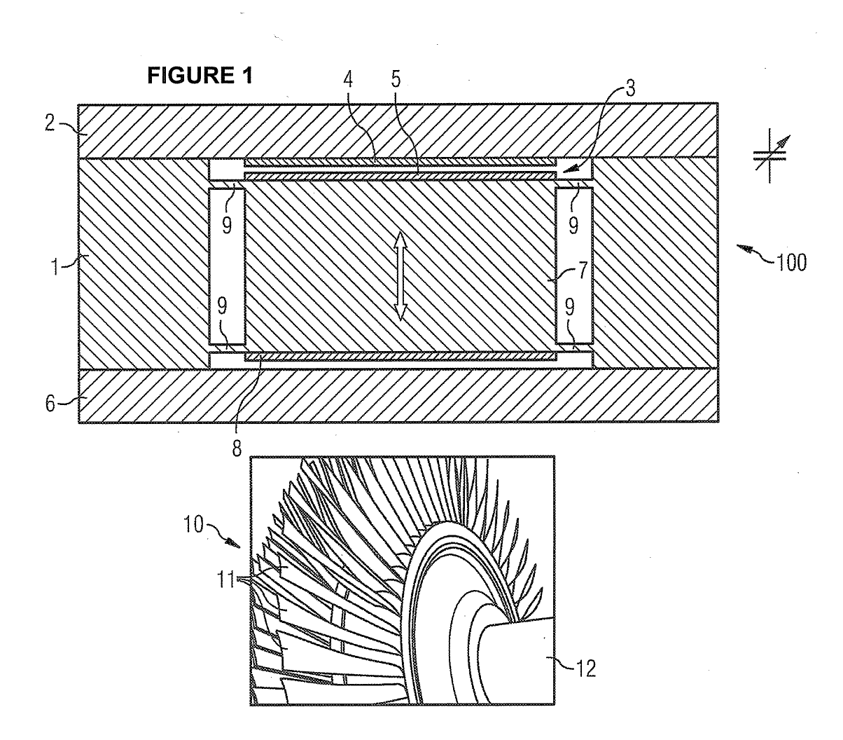

In accordance with the exemplary embodiment an energy conversion unit 100 (see FIG. 1) is used as an energy source in the form of a capacitive micro power generator.

This unit 100 includes an electrode unit 3 with a first electrode 4 and a second electrode 5. The first electrode 4 and the second electrode 5 are arranged at a variable distance from each other. For this purpose the second electrode 5 is arranged on a spring-mounted additional mass 7 of a first wafer 1. The first wafer 1 can for example be made of silicon. The additional mass 7 is connected to the wafer 1 by for example four strips 9. The additional mass 7 can be produced by applying the second electrode 5 from a first surface of the first wafer 1 and one or several subsequent etching operations from a second surface opposite the first surface of the wafer 1. The first electrode 4 is arranged on a second wafer 2, e.g. of silicon or SiO2. The first and second wafers 1, 2 are connected to each other in such a way that the first electrode 4 and the second electrode 5 rest opposite each other. Whereas the first electrode 4 is permanently fixed in position the second electrode 5 can move in the direction of the arrow. The first and the second electrodes 4, 5 can for example be made of platinum, titanium and/or platinum-titanium or of gold.

On the second surface of the wafer 1 a third wafer 6 is arranged which likewise is made of Si or SiO2. The additional mass 7 with the electrode structure 3 is thus located in the cavity formed between the second wafer 2 and the third wafer 6 as well as the first wafer 1, which cavity can be evacuated in order to minimize friction losses in the movement of the additional mass 7. This makes it possible to increase the efficiency of the energy conversion unit.

The first electrode 4 and the second electrode 5 are connected to each other in an electrically conductive manner via a load circuit not shown in FIG. 1. Before the start of a change in distance, the first and second electrodes 4, 5 exhibit a difference in potential which is caused by the electrical connection of the first and second electrodes via the load circuit and is attributable to the alignment of the Fermi levels of the first and second electrodes. The difference in potential can be brought about by charging the electrode structure 3 using an electret or a charge capacitor or by utilizing a difference in the work functions of the materials of the first and the second electrodes. A capacitor formed from the first electrode 4 and second electrode 5 thus exhibits an integrated bias voltage. As a result of the electrically conductive connection via the load circuit between the first electrode 4 and second electrode 5, a current flows corresponding to the difference in potential of the first electrode 4 and second electrode 5. A change in the distance of the second electrode 5 from the first electrode 4 causes a change in the capacitance of the capacitor and leads to a current flow between the two electrodes which can be converted into electrical energy by the load circuit not shown.

A transmitter 8 is arranged on the second surface of the additional mass 7 located opposite the second electrode 5. The transmitter 8 is formed by a permanent magnetic layer or a permanent magnet. The transmitter can for example be made of Nd—Fe—B or Fe—Co—V. The transmitter 8 interacts magnetically with a further transmitter which is arranged on a rotational machine 10. In the exemplary embodiment the rotational machine 10 is a turbine rotor which exhibits numerous blades 11 which are mounted on a shaft 12. The further transmitter can for example be formed by the blade material which usually consists of a ferromagnetic material. Frequently Fe, Co or Ni are used for this. If the blades 11 are not made of a ferromagnetic material permanent magnets could be arranged on their ends facing away from the shaft 12 and perform the function of the further transmitter.

The energy conversion unit 100 is for example located in a housing in a rotation level of the turbine rotor, which housing encloses the rotating turbine rotor. The transmitter 8 faces towards the turbine rotor. The rotation of the turbine rotor leads to a contactless magnetic interaction with the transmitter 8, whereby the movement thus induced causes a movement of the additional mass 7 coupled to the transmitter and thus of the second electrode 5, which brings about the change in distance from the first electrode 4. Through the rotation of the turbine blade the additional mass 7 is therefore periodically displaced so that the resulting oscillation of the additional mass 7 leads to a periodic change in the distance between the first and second electrodes 4, 5. The current flowing between the first and second electrodes 4, 5 via the load circuit can be used to obtain energy.

The further transmitter could also be arranged on or in the area of the shaft 12 of the rotational machine 10. The further transmitters made of ferromagnetic material or in the form of permanent magnets are then periodically arranged over the circumference of the shaft 12. This leads to a periodic displacement or oscillation of the additional mass 7 and thus of the second electrode 5.

The capacitive generator offers the advantage of providing an autonomous energy supply to a microsystem for use in rotational machines. The energy converter makes it possible to create a diagnostic tool which essentially does not require any design change to the actual rotational machine. The microsystem enables specific tasks to be performed directly at the desired location at the desired time.

The capacitive energy converter can be realized in CMOS technology at wafer level and can be directly integrated on-chip in a microsystem.

The capacitive generator essentially represents a spring-mass system which is able to convert the mechanical energy of the moving parts of the rotational machine contactlessly into electrical energy. The electrical energy is available for the autonomous microsystem or it can be intermediately stored. The mechanical energy to be converted is translated into a periodic displacement of the spring-mass system by magnetic interaction. In order to produce the change in distance between the electrodes of the energy converter a permanent magnetic layer or a permanent magnet has to be coupled to one of the electrodes or to the additional mass connected to the electrode structure. A ferromagnetic material or a permanent magnet is also provided on the rotational machine in order to ensure the magnetic interaction between the rotational machine and the actual energy converter.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-19. (canceled)

20. An energy device associated with a load circuit, said device comprising:
an energy conversion unit having an electrode structure for the capacitive conversion of mechanical energy into electrical energy and comprising a first electrode and a second electrode at a variable distance from the first electrode, with the load circuit connecting the first and the second electrodes and
a transmitter coupled to the second electrode, whereby through a movement of the transmitter the distance between the first and the second electrodes is variable and whereby the movement of the transmitter can be brought about contactlessly through interaction of the transmitter with a moving part.

21. The device as claimed in claim 20, wherein the movement of the transmitter is brought about by magnetic interaction of the transmitter with the moving part, sections of which exhibit magnetic properties.

22. The device as claimed in claim 20, wherein the movement of the transmitter is brought about by a rotating part, so that a periodic movement or oscillation of the transmitter is induced.

23. The device as claimed in claim 20, wherein the transmitter exhibits permanent magnetic properties.

24. The device as claimed in claim 23, wherein the transmitter comprises a permanent magnetic layer or a permanent magnet.

25. The device as claimed in claim 20, wherein the first and second electrodes exhibit a difference in potential before a start of a change in distance.

26. The device as claimed in claim 25, wherein the electrode structure is charged by an electret or a charging capacitor or by utilizing a difference in work functions of the materials of the first and the second electrodes.

27. The device as claimed in claim 20, wherein the second electrode is arranged on a spring-mounted mass and the transmitter is provided on the mass.

28. The device as claimed in claim 27, wherein the second electrode and the transmitter are arranged on opposite surfaces of the mass.

29. The device as claimed in claim 27, wherein the spring-mounted mass is formed in a first wafer, whereby on a first surface of the first wafer a second wafer is applied on which, facing towards the second electrode on the mass, the first electrode is located at a distance from the second electrode.

30. The device as claimed in claim 29, wherein a second surface of the first wafer which is opposite a first surface a third wafer is arranged so that the mass can oscillate with the second electrode and the transmitter in an encapsulated cavity.

31. The device as claimed in claim 20, wherein the electrode structure is provided as a spring-mass system with a resonance frequency in such a way that the resonance frequency this lies within a frequency band of a movement of the part interacting with the transmitter.

32. The device as claimed in claim 31, herein the resonance frequency of the electrode structure can be adjusted in particular by varying the mass and/or spring rigidity.

33. The device as claimed in claim 20, wherein the energy conversion unit is configured as a sensor, as an actuator, for use in data communication and/or in automotive and automation technology and/or as an energy source and/or as a signal transmitter and/or as a diagnostic tool.

34. A system with a moving part and a device as recited in claim 20, whereby through movement of the part a mechanical movement of the transmitter can be produced contactlessly by interaction with the part, whereby the mechanical movement of the transmitter can be converted by the device into electrical energy.

35. The system as claimed in claim 34, wherein the moving part is a rotational machine.

36. The system as in claim 35, wherein a second means of transmission which contactlessly displaces the transmitter is provided at regular intervals on the moving part.

37. The system as in claim 36, wherein the second means of transmission is formed by a ferromagnetic material, in particular iron, cobalt or nickel, or a permanent magnet.

38. The system as in claim 36, wherein the second means of transmission is formed by the rotational machine itself or is arranged on it.
